(19) United States
(12) Patent Application Publication
(10) Pub. No.: US 2005/0050280 A1
(43) Pub. Date: Mar. 3, 2005

(54) Data accessing method and system for processing unit

(75) Inventors: Chang-Cheng Yap, Hsin Chu (TW); Shih-Jen Chuang, Hsin Chu (TW)

Correspondence Address: EDWARDS & ANGELL, LLP, P.O. BOX 55874, BOSTON, MA, 02205, US

(73) Assignee: RDC Semiconductor Co., Ltd.

(21) Appl. No.: 10/830,592

(22) Filed: Apr. 22, 2004

(30) Foreign Application Priority Data
Aug. 29, 2003 (TW) 092123880

(51) Int. Cl. G06F 12/00

(52) U.S. Cl. 711/137; 712/207

(57) ABSTRACT

A data accessing method and a system for use with the same are provided. A processing unit reads a command from a memory unit and decodes the command. Then, the processing unit determines if the command requires pre-fetching of data that are not stored in a cache or a buffer unit; if yes, the processing unit sends a fetching request to the memory unit according to addresses of data to be fetched and pre-fetched. Moreover, the processing unit reads the data to be fetched from the memory unit and stores the data to be pre-fetched in the buffer unit. Thereby, the above method and system can achieve data pre-fetching accurately.

### FIELD OF THE INVENTION

The present invention relates to data accessing methods and systems, and more particularly, to a data accessing method and system implemented by commands within a processing unit.

### BACKGROUND OF THE INVENTION

High-performance data processing devices are currently under increasing demand; the most indispensable one among them is the processing unit. For example, the central processing unit (CPU) on a personal computer provides functions of accessing, decoding and executing commands, and transmitting and receiving data from other data sources via a data transmission path, such as a bus. In order to achieve high performance, on Intel i486 (or products with similar level manufactured by other processing unit manufacturers) or other high-end processing unit, within which mostly an internal L1 or L2 cache is constructed. Cache usually exists between the CPU and main memory, and usually consists of a static random access memory (SRAM). When the CPU wishes to read data, firstly the data stored in the internal cache is read, if the data is not read, then the external cache is read, if the desired data is still not read, then data reading is performed to the main memory. Cache usually performs fast data accessing by copying data. Cache stores the contents within the main memory locations that are frequently accessed, and stores the addresses of these data entries. Cache checks whether these addresses are kept, if the addresses are found to exist, then immediately send the data back to the CPU, if not found, then immediately performs the normal main accessing access procedures.

When the access speed of the CPU is faster than the main memory unit, the existence of the cache is very important, because the access speed of cache is faster than the main memory. However due to the limitation of processing techniques and costs, capacity of cache is much smaller compared to the main memory. Usually the capacity of an internal cache is 8 Kbytes to 64 Kbytes; and the capacity of an external cache is between 128 Kbytes and 1 Mbytes. Compared to a main memory that usually has hundreds of Mbytes to several Gbytes, the data that can be stored in a cache is relatively limited.

When commands occur that require repeatedly access to a large amount of data with successive addresses in the main memory, CPU usually spends a considerably amount of time waiting for the data to arrive. In order to improve the time wasted in waiting for the data to arrive, a data pre-fetching mechanism is necessary. If data pre-fetching is achieved through the use of cache as described above, i.e. through hardware, then the capacity of the cache has to increase. Increasing the capacity of which usually increases cache-hit rate, thereby reducing the chances and latency when reading data directly from the main memory. In practice, however, the increase of cache capacity is not guaranteed to result in increase in data accessing speed. Since the cache predicts the next data content to be read by the CPU according to the signals communicated with the CPU. Yet this method cannot achieve full accuracy of the data pre-fetched.

Therefore a method and system that provides an accurate data pre-fetching of the processing unit is required.

### SUMMARY OF THE INVENTION

In order to solve the problem of the prior art, a primary objective of the present invention is to provide a data accessing method and system for a processing unit, commands for repeat and successive data accessing are executed by the processing unit, and the data pre-fetched is stored in a buffer unit, thereby eliminating the time of waiting for the data to arrive.

Another objective of the present invention is to provide a data accessing method and system for a processing unit, commands for repeat and successive data accessing are executed by the processing unit, thereby fully predicting the subsequent data to be read by the processor unit.

In order to achieve the above objectives, the processing unit data accessing system of the present invention comprises: a bus unit built inside the processing unit, which is used to fetch commands from the main memory and is responsible for data transmission between the processing unit and peripheral devices; a command unit built inside the processing unit used to read and decode the command contents fetched by the bus unit or fetched from a cache; a cache that is used to cache the contents frequently accessed by the main memory and record the addresses of those stored data entries, thereby allowing the processing unit to access data quickly; and a load store unit (LSU) built inside the processing unit that is used to load the data read from the main memory via the bus unit into an execution unit, and store execution results of the execution unit into the main memory via the bus unit, wherein, the LSU further comprises a buffer unit.

Through the data accessing system for the processing unit, the method of performing the data accessing for the processing unit includes having the bus unit fetch data accessing command from the main memory; next, having the command unit read and decode the command content fetched by the bus unit; then having the LSU load the data read from the main memory by the bus unit into the execution unit, and having the execution unit perform the data accessing command decoded by the command unit, thereby determining whether the command requires data pre-fetching, and that the pre-fetching data is not yet stored in either the cache or the buffer unit; if so, then having the processing unit send a fetching request to the main memory according to the data addresses to be fetched and pre-fetched; and having the bus unit read the fetched data and store the pre-fetched data in the buffer unit, allowing LSU to access subsequent commands from the buffer unit.

Compared to the conventional processing unit data accessing system and method, the data accessing method and system of the present invention provides the functionality of processing unit not having to wait for data to arrive, and further obtains the full prediction about the data to be subsequently read by the processing unit.

### BRIEF DESCRIPTION OF THE DRAWINGS

A better understanding of the present invention can be obtained when the forgoing detailed description is considered in conjunction with the following drawings, in which:

FIG. 1 is a block diagram showing the system architecture of the processing unit data accessing system according to the present invention; and

FIG. 2 is a flowchart showing steps when performing the data processing data accessing according to the processing unit data accessing method of the present invention.

### DETAILED DESCRIPTION OF THE PREFFERED EMBODIMENT

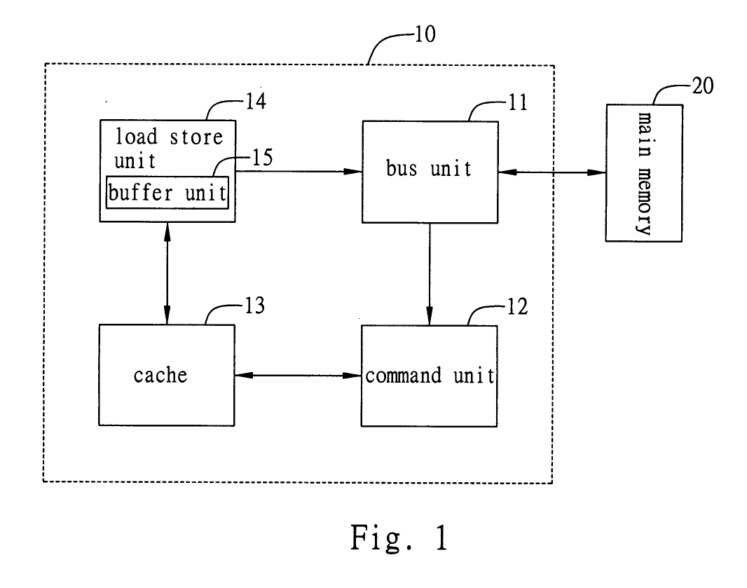

Referring to FIG. 1, wherein a structure of the processing unit data accessing system of the present invention is shown. In this embodiment, the processing unit data accessing system is applicable to a processing unit 10 which conforms to the X86 architecture, the processing unit 10 comprises: a bus unit 11, a command unit 12, a cache 13, a load store unit (LSU) 14 and a buffer unit 15. Note that the processing unit 10 further comprises other components and modules, such as registers and I/O unit etc., but only the ones related to the present invention are illustrated.

The bus unit 11 is constructed in the processing unit used to fetch commands from a main memory 20, and the bus unit 11 is responsible for transmitting data between the processing unit 10 and the external peripheral devices (not shown). The main memory 20 can be is a volatile random access memory, such as SRAM (static random access memory), DRAM (dynamic random access memory), SDRAM (synchronous dynamic random access memory), DDR-SDRAM (double-data rate synchronous dynamic random access memory), etc. The bus unit 11 can include an address bus responsible for transmitting the address of data to be accessed the processing unit 10, and determines the memory capacity that can be processed by the processing unit 10, wherein N address lines can have 2^{N} memory space, and the addresses is from 0 to 2^{N}−1; a data bus used to transmit the data to be accessed by the processing unit 10, the number of lines represents the words of the processing unit, that is, the basic units the processing unit 10 can access at one time; and a control bus used to transmit the control signals sent from the processing unit 10.

The command unit 12 is constructed in the processing unit 10 and reads the command content fetched from the main memory 20 or the cache 13 via the bus unit 10 and decodes it.

The cache 13 is used to perform fast data accessing by copying data. By storing the contents of those main memory locations that are frequently accessed, and storing the addresses of those data entries, the processing unit 10 is able to access data quickly. In this embodiment, the cache 13 is constructed in the processing unit 10 and allows the processing unit to access data quickly.

The LSU 14 is constructed in the processing unit 10, and is used to load the data read from the main memory 20 via the bus unit 11 into an execution unit (not shown), and stores the result executed by the execution unit into the main memory 20 via the bus unit 11. In addition, the LSU 14 can further perform moving and replacing of the data location of the main memory 20.

The buffer unit 15 constructed in the LSU 14, and is used to provide the LSU 14 a temporarily storage for data that is pre-fetched from the main memory 20 by the bus unit 11 according to a command, thereby allowing the LSU 14 to execute the pre-fetched and stored command in the buffer unit 15 after completing executing the current command.

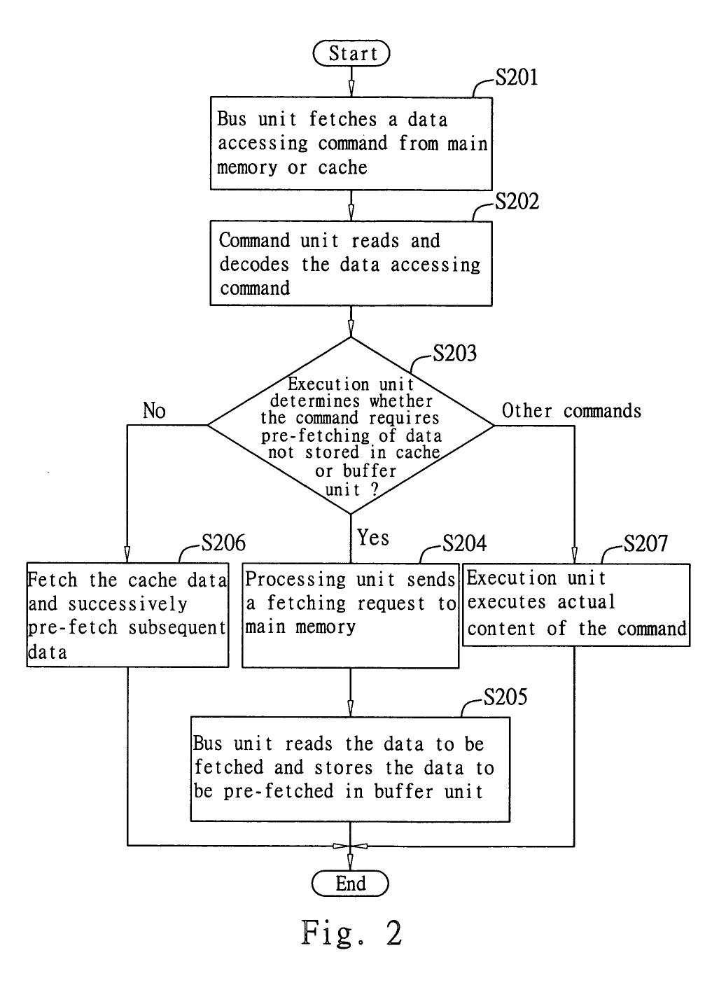

Referring now to FIG. 2, wherein the processing unit data accessing method of the present invention is shown. Note that in this embodiment, when it is necessary to repeatedly decode commands for reading large blocks of memory, through the above processing unit data accessing system, the functionality of pre-fetching current/subsequent successive locations of main memory 20 to be read is provided, which shortens the waiting time for arrival of data from the main memory 20 and improves the efficiency of the processing unit 10, the command of the processing unit 10 achieving the above advantages comprises at least the following content:

1. REP MOVS :

if data is in cacheable region and MEMW hit cache then

burst MEMR address A0
burst MEMR address A0+clength ( or A0−clength ) where

clength is the byte length of cache line

burst MEMR address A0+2*clength ( or A0−2*clength )
... ( other actions )

else if data is in cacheable region but MEMW not hit cache

burst MEMR address A0
repeat MEMW N times
burst MEMR address A0+clength ( or A0−clength )
repeat MEMW N times
burst MEMR address A0+2*clength ( or A0−2*clength )
... ( other actions )

else if data is in non-cacheable region

MEMR address A0
MEMW
MEMR address A0+Ainc ( or A0−Ainc )
MEMW
MEMR address A0+2*Ainc ( or A0−2*Ainc )
MEMW
... ( other actions )

2. REP SCAS :

if data is cacheable

burst MEMR address A0
burst MEMR address A0+clength ( or A0−clength )
burst MEMR address A0+2*clength ( or A0−2*clength )
... ( other actions )

else if data is non-cacheable

MEMR address A0
MEMR address A0+Ainc ( or A0−Ainc )
MEMR address A0+2*Ainc ( or A0−2*Ainc )
... ( other actions )

3. REP OUTS :

if data is cacheable

burst MEMR address A0
repeat IOW N times
burst MEMR address A0+clength ( or A0−clength )
repeat IOW N times
burst MEMR address A0+2*clength ( or A0−2*clength )
... ( other actions )

else if data is non-cacheable

MEMR address A0
IOW
MEMR address A0+Ainc ( or A0−Ainc )
IOW
MEMR address A0+2*Ainc ( or A0−2*Ainc )
IOW
... ( other actions )

It is note that N in the above command is set according to the type of REP MOVS or REP OUTS, if it is double-word accessing, N equals clength*8/32; if it is word accessing, then N equals (clength*8/16+clength*8/32) or clength*8/16; if it is byte accessing, N equals clength*8/8. In addition, Ainc is set according to the data type, if it is double-word accessing, Ainc equals 4; if it is word accessing, then Ainc equals 2; if it is byte accessing, then Ainc equals 1.

In step S201, the bus unit 11 fetches data fetches command from the main memory 20, then performing step S202.

In step S202, the command unit 12 reads the command fetched by the bus unit 11 and decodes it, then performing step S203.

In step S203, the LSU 14 loads the data read from the main memory 20 via the bus unit 11 into the execution unit, so that the execution unit can execute the data accessing command decoded by the command unit 12 in order to determine whether the command calls for data pre-fetching, and the pre-fetching data is not stored in either the cache 13 or the buffer unit 15, if so, then performing step S204, else performing step S206; if it is some other command, then performs step S207.

In step S204, the bus unit 11 sends fetching request to the main memory 20 according to the data addresses to be fetched and pre-fetched, then performing S205.

In step S205, the bus unit 11 fetches the data to be fetched, and stores the data to be pre-fetched into the buffer unit 15 of the LSU 14.

In step S206, the bus unit 11 fetches the data stored in the cache 13, and successively pre-fetches data subsequently follows the fetched data according to command.

In step S207, the LSU 14 executes the data accessing command decoded by the command unit 12.

According to the above, through the processing unit command for repeatedly fetching successive data, the bus unit 11 can send the next memory-fetching request in advance to the main memory 20, and after fetching the first data, the subsequent data is stored in the buffer unit 15, which will be used by the second fetching request of the LSU 14, thereby obtaining the objective of not having to wait the time for fetching from the main memory 20. In another perspective, when the LSU 14 reads data from the buffer unit 15, the bus unit 11 has to fetch the subsequent data according to the command until the number of times for repeat is over.

In summary, the processing unit data accessing method and system of the present invention not only eliminate the time the processing unit has to wait for data accessing, they also achieve full prediction of the subsequent data to be read by the processing unit.

The above embodiments are only to illustrate, not limit, the principles and results of the present invention. Any person with ordinary skill in the art can make modifications and changes to the above embodiments, yet still within the scope and spirit of the present invention. Thus, the protection boundary seek by the present invention should be defined by the following claims.

1. A data accessing method for use in a data processing device having a processing unit, the method comprising the steps of:
having a bus unit fetch a data accessing command from a main memory;
having a command unit read the content of the data accessing command fetched by the bus unit and decode the command;
having a load store unit load the data fetched from the main memory into an execution unit, so as to allow the execution unit to execute the data accessing command decoded by the command unit and determine whether the command requires pre-fetching of data that are not stored in a cache or a buffer unit; if yes, having the processing unit send a fetching request to the main memory according to addresses of data to be fetched and pre-fetched; and
having the bus unit read the data to be fetched and store the data to be pre-fetched in the buffer unit so as to be allow the load store unit to fetch a successive command from the buffer unit.

2. The method as claimed in claim 1, wherein if the decoded data accessing command requires pre-fetching of data, and the data to be pre-fetched are stored in the cache and the buffer unit, then it is to fetch data from the cache and successively pre-fetch subsequent data.

3. The method as claimed in claim 1, wherein in case of the decoded data accessing command not requiring pre-fetching of data, and the data to be pre-fetched are not stored in the cache or the buffer unit, then it is to have the load store unit execute actual content of the data accessing command.

4. The method as claimed in claim 1, wherein the processing unit is a central processing unit or a microprocessor.

5. The method as claimed in claim 4, wherein the central processing unit and the microprocessor have X86 command architecture.

6. The method as claimed in claim 1, wherein the data processing device is a personal computer, a notebook, a palm pilot, a personal digital assistant (PDA), a flat-panel computer, a server system or a workstation.

7. The method as claimed in claim 1, wherein the main memory is a volatile random access memory.

8. The method as claimed in claim 7, wherein the main memory is a dynamic random access memory, synchronous dynamic random access memory, static random access memory, or a double-data rate synchronous dynamic random access memory.

9. The method as claimed in claim 1, wherein the cache is a static random access memory.

10. The method as claimed in claim 1, wherein the buffer unit is constructed in the load store unit.

11. A data accessing system for use in a data processing device having a processing unit, the system comprising:
a bus unit constructed in the processing unit and for fetching commands from a main memory and transmitting data between the processing unit and external peripheral devices;
a command unit constructed in the processing unit and for reading and decoding content of the commands fetched by the bus unit;
a cache for storing data content of those main memory locations that are frequently accessed, and recording addresses of those stored data entries, so as to allow the processing unit to access data quickly; and
a load store unit constructed in the processing unit and for loading data read via the bus unit from the main memory into an execution unit and storing executed results from the execution unit into the main memory via the bus unit.

12. The system as claimed in claim 11, wherein the processing unit is a central processing unit or a microprocessor.

13. The system as claimed in claim 12, wherein the central processing unit and the microprocessor have X86 command architectures.

14. The system as claimed in claim 11, wherein the data processing device is a personal computer, a notebook, a palm pilot, a personal digital assistant (PDA), a flat-panel computer, a server system or a workstation.

15. The system as claimed in claim 11, wherein the main memory is a volatile random access memory.

16. The system as claimed in claim 15, wherein the main memory is a dynamic random access memory, synchronous dynamic random access memory, static random access memory, or a double-data rate synchronous dynamic random access memory.

17. The system as claimed in claim 11, wherein the cache is a static random access memory.

18. The system as claimed in claim 11, wherein the load store unit is further for moving or replacing the data locations of the main memory.
